(19) United States
(12) Patent Application Publication
(10) Pub. No.: US 2025/0110518 A1
(43) Pub. Date: Apr. 3, 2025

(54) VOLTAGE REGULATOR INCLUDING CURRENT AND VOLTAGE SENSORS

(71) Applicants: Takao Oshita, Portland, OR (US); Anindya Saha, Portland, OR (US); Nasirul Chowdhury, Portland, OR (US); Christopher P. Mozak, Portland, OR (US)

(72) Inventors: Takao Oshita, Portland, OR (US); Anindya Saha, Portland, OR (US); Nasirul Chowdhury, Portland, OR (US); Christopher P. Mozak, Portland, OR (US)

(21) Appl. No.: 18/374,813

(22) Filed: Sep. 29, 2023

(51) Int. Cl. G05F 1/575; G05F 1/565

(52) U.S. Cl. CPC G05F 1/575; G05F 1/565

(57) ABSTRACT

Some embodiments include an apparatus having a low-dropout (LDO) voltage node; a driver including an output node coupled to the LDO voltage node to provide a current at the LDO voltage node; a comparator including an input node coupled to the output node of the driver and an output node coupled to an input node of the driver; a current generator coupled to the driver to generate a second current based on the first current; and a frequency compensation network coupled to the comparator and the current generator.

### BACKGROUND

Voltage regulators are used in many electronic devices or systems, such as computers, tablets, cellular phones, and Internet of Things (IoT). A voltage regulator converts an input voltage (e.g., from a battery or other power source) into a voltage that is appropriate for use by components of the device or system. With the newly emerging chiplet technology, multiple chiplets are placed on a silicon interposer for integration. In addition to massive metal interconnects, the silicon interposer can contain various passive components including a metal-insulator-metal (MIM) capacitor, which is often used for the stability of the power system in the chiplets. Under such constraints, a low-dropout (LDO) voltage regulator can be used to take an advantage of the MIM capacitor on the silicon interposer.

The challenge on such a LDO voltage regulator design under such constraint is such that a LDO voltage regulator often needs to cover a wide range of output capacitance during different stages of production of the device or system that includes the LDO voltage regulator. Further, there is often a demand on the high performance LDO voltage regulator that covers a wide range of load current. However, it is a challenge to design a LDO voltage regulator that can support both a wide range of load current and fast response time of the LDO voltage regulator.

One conventional technique to improve the response time of the LDO voltage regulator against a high frequency voltage droop is to add an open-loop branch that operates based on previously measured statistical data. This technique is useful to suppress alternating current (AC) voltage droop that is faster than what the feedback loop (e.g., closed-loop) of LDO voltage regulator can support when AC noise profile is predictable in advance. However, due to limitations such as mismatch between the predicted and actual load current, the LDO voltage regulator in the conventional technique may not achieve desired performance. Moreover, current measurement in a LDO voltage regulator is often included in design features of a LDO voltage regulator. However, it is a challenge to achieve current measurement in a LDO voltage regulator with accuracy at an acceptable cost.

### BRIEF DESCRIPTION OF THE DRAWINGS

FIG. 1 shows an apparatus including a voltage regulator, according to some embodiments described herein.

FIG. 2 shows an example Bode plot of an open-loop frequency response of the voltage regulator of FIG. 1 across process, voltage, and temperature (PVT), according to some embodiments described herein.

FIG. 3 shows an example transition of an open-loop frequency response of the voltage regulator of FIG. 1, according to some embodiments described herein.

FIG. 4 shows an apparatus including another voltage regulator, according to some embodiments described herein.

FIG. 5A shows an apparatus including a voltage regulator having open-loop control circuitries and load circuits coupled to the voltage regulator, according to some embodiments described herein.

FIG. 5B shows details of an open-loop control circuitry that represents one of the open-loop control circuitries of FIG. 5A, according to some embodiments described herein.

FIG. 6 shows a code generator including compensation circuitry, according to some embodiments described herein.

FIG. 7 shows an example voltage variation at an output node of the voltage regulator of FIG. 5A using code information provided from the compensation operation associated with FIG. 6, according to some embodiments described herein.

FIG. 8A shows the voltage regulator of FIG. 5A and offset calibration circuitry, according to some embodiments described herein.

FIG. 8B shows an example of variation of a voltage at an output node of the voltage regulator of FIG. 8A associated with activations of load circuits during an offset calibration operation, according to some embodiments described herein.

FIG. 8C shows an example histogram of the variation of the voltage at the output node of the voltage regulator of FIG. 5A, according to some embodiments described herein.

FIG. 8D shows code information including offset information that are provided to open-loop control circuitry of the voltage regulator of FIG. 8A, according to some embodiments described herein.

FIG. 9A shows a current sensor of the voltage regulator of FIG. 1 or FIG. 4, according to some embodiments described herein.

FIG. 9B is a timing diagram showing waveforms for some of the signals of the current sensor of FIG. 9B, according to some embodiments described herein.

FIG. 10 shows an apparatus in the form of a system, according to some embodiments described herein.

FIG. 11 shows a method of operating an apparatus that can include a voltage regulator, according to some embodiments described herein.

### DETAILED DESCRIPTION

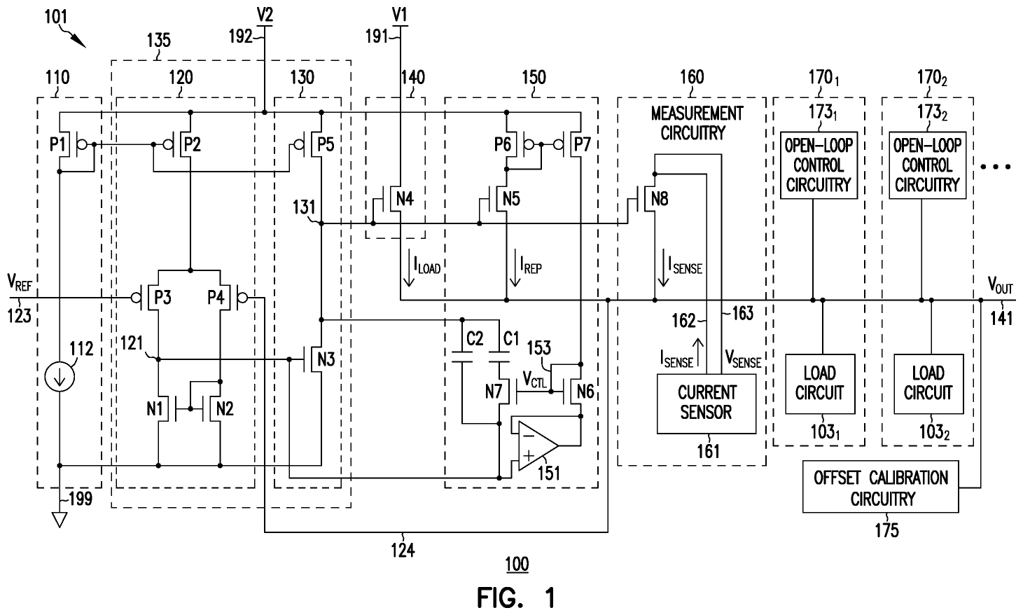

The techniques described herein involve a LDO voltage regulator that can support a wide operating range of output capacitance (e.g., 0 to 50 nanofarads (nF)) and a wide range of load current (e.g., 0 to 250 milliamperes (mA)) while having little impact on performance of the LDO voltage regulator. Further, the LDO voltage regulator also includes an open-loop control circuit (open-loops branch), which enables a rapid response to high frequency voltage droop that is predictable in advance. The described techniques include voltage sensing and calibration operation to achieve an improved performance of the open-loop control circuit in comparison with some conventional techniques. Moreover, the described techniques include measurement circuitry and its calibration operation. The measurement circuitry can provide an accurate measurement of both open-loop and closed-loop load current profiles of the voltage regulator. The results of the current measurement can be useful for power debug and the power management of devices or system in a silicon chip. These and other improvements and benefits of the described techniques are discussed in more detail below with reference to FIG. 1 through FIG. 11.

FIG. 1 shows an apparatus 100 including a voltage regulator 101, according to some embodiments described herein. As described above, it is a challenge to design a LDO voltage regulator that covers a wide operating range of the output capacitance (e.g., 0 to 50 nF) and load current (e.g., 0 to 250 mA). Such a challenge often includes difficulty in maintaining loop stability in a wide operating range. For example, when the LDO voltage regulator output node has a relatively large output capacitance, the LDO voltage regulator control loop becomes a multiple pole system. Voltage regulator 101 includes a mechanism (e.g., circuitry) to inject zero to cancel out one of the poles for the loop stability if two poles are close together. As described below, the mechanism of voltage regulator 101 can also operate to selectively enable and disable zero in the control loop to support different usage cases. For example, in a case where the output node of voltage regulator 101 has almost zero capacitance (e.g., during the wafer-level testing), the control loop of voltage regulator 101 becomes a single pole system. In this case, the mechanism of the voltage regulator can disable zero in the control loop.

When a large MIM capacitor exists at the output node of a LDO voltage regulator, additional technique is often needed to ensure the loop stability. Under such condition, when the load current is low, the output node of LDO voltage regulator tends to become the primary pole. If the load current gets higher, the pole at the output node of the LDO voltage regulator tends to move towards the higher frequency and eventually becomes the non-dominant pole. Loop stability degrades when two poles are close together. Thus, as mentioned above, voltage regulator 101 can operate to inject zero to cancel out one of the poles. If the pole moves, the zero of voltage regulator 101 can follow the pole. This can be referred to as adaptive zero (or adaptive zero mechanism) in voltage regulator 101. Since the location of the pole is a function of load current, the sensing capability of the load current is often needed to achieve such functionality. As described below, voltage regulator 101 includes a current sensing mechanism to improve open-loop control of voltage regulator 101. The information of the load current can be used to significantly improve the performance of voltage regulator 101 by implementing the adaptive zero in the frequency domain to change the frequency response characteristics. The adaptive zero mechanism described herein contributes to the loop stability while having little affect the response time of voltage regulator 101. As described below, due to circuit implementation of voltage regulator 101, both loop stability and response time can be improved.

In FIG. 1, apparatus 100 can include or be included in an electronic device or system, such as a computer (e.g., desktop, laptop, or notebook), a tablet, a cellular phone, a system on chip (SoC), a system in a package (SiP), or other electronic devices or systems. Voltage regulator 101 can operate to receive a voltage (e.g., input voltage) V1 at a node (e.g., supply node) 191 and provide a voltage (e.g., output voltage or output signal) V_{OUT} at a node 141 that is based on voltage V1. In this description, a node can include or can be part of a conductive line. The terms “node” and “line” (e.g., conductive line) are used interchangeably. Voltage V1 at node (or conductive line) 191 can be a supply voltage provided by a power source (e.g., a battery) or by another voltage generator (e.g., a voltage converter). The value of voltage (output signal) V_{OUT} can be based on the value of voltage V1. In an example, the value of voltage V_{OUT} can be less than the value of voltage V1 by a relatively small amount, such that a drop in voltage from voltage V1 to voltage V_{OUT} is relatively low. Thus, voltage regulator 101 can be called a LDO voltage regulator and node 141 can be called LDO voltage node.

Voltage at node (low-dropout voltage node) 141 can be provided (e.g., as a supply voltage) to other components, such as load circuits 103₁ and 103₂, of apparatus 100. FIG. 1 shows two load circuits 103₁ and 103₂ as an example. However, voltage at node 141 can be provide to fewer or more than two load circuits. Examples of load circuits (e.g., load circuits 103₁ and 103₂) can include clock generator circuits, phase interpolation circuits, buffer circuits, delay locked-loop circuits, circuits associated with a processor (e.g., a central processing unit (CPU) or a graphics processing unit (GPU)), circuits associated with a memory device, and other electronic components of apparatus 100. In FIG. 1, voltage regulator 101 can include (or can be included in) an integrated circuit (IC) chip (e.g., semiconductor chip) of apparatus 100. The IC chip can include a semiconductor die (e.g., silicon-based die). In an example, voltage regulator 101 and load circuits 103₁ and 103₂ can be included in separate IC chips (e.g., separate IC dies). In another example, voltage regulator 101 and load circuits 103₁ and 103₂ can be included in the same IC chip (e.g., same die).

As shown in FIG. 1A, voltage regulator 101 can include transistors P1, P2, P3, P4, P5, P6, P7, N1, N2, N3, N4 N5, N6, and N7, capacitors C1 and C2, current generator 110, and a comparator 151. Voltage regulator 101 can include a node (e.g., supply node) 199 (which can be part of a supply voltage connection (e.g., ground connection) of apparatus 100). Node 199 can receive a voltage Vss (e.g., supply voltage) that can be ground potential.

Transistors N1 through N7 can include n-type (e.g., n-channel) transistors. An example of an n-type transistor includes n-channel metal-oxide-semiconductor field-effect transistors (silicon n-channel MOSFET or commonly called NMOS). Other n-type transistors can be used. Transistors P1 through P7 can include a p-type (e.g., p-channel) transistors. An example of an p-type transistor includes p-channel metal-oxide-semiconductor field-effect transistor (silicon p-channel MOSFET or commonly called PMOS). Other p-type transistors can be used.

As shown in FIG. 1, transistor P1 and current source 112 can be part of (e.g., can form) a bias generator 110. Transistors P2, P4, P4, N1, and N2 can be part of (e.g., can form) a differential amplifier 120 as a first stage. Transistors P5 and N3 can be part of (e.g., can form) a buffer (e.g., a class A buffer circuit) 130 as a second stage. The combination of differential amplifier 120 and buffer 130 can form a comparator 135 of voltage regulator 101. Transistor N4 can be part of (e.g., can form) a driver (e.g., an output driver) 140. Voltage regulator 101 can include nodes 121 and 131. Driver 140 can have an input node (e.g., at the gate of transistor N4) coupled to node 131. Driver 140 can have an output node coupled to node 141 to provide voltage V_{OUT} and a current I_{LOAD}. As shown in FIG. 1, transistor N4 can have a terminal (e.g., drain) coupled to supply node 191 and a terminal (e.g., source) coupled to node 141.

Node 121 can be called the output node of differential amplifier 120 that can also be the output node of comparator 135. Node 131 can be called the output node of buffer 130 that can also be the output node of comparator 135. The gates of transistors P3 and P4 can form input nodes (e.g., “+” and “−” input nodes, respectively) of differential amplifier 120 that can also be the input nodes of comparator 135. Node 141 can be called the output node of driver 140 that can also be the output node of voltage regulator 101. Transistors P6, P7, N5, N6, and N7, capacitors C1 and C2, and comparator 151 can be part of (e.g., can form) a control circuit 150. Transistor P6, P5, N5 and N6 can form part of a current generator (e.g., a current mirror) to generate a current I_{REP} in which transistors P6 and N5 can form one branch of the current mirror (to conduct current I_{REP}) and transistors P7 and N6 can form another branch of the current mirror. Current (e.g., mirrored current) I_{REP} can be generated based on current I_{LOAD} (which is conducted through transistor N5) based on current I_{LOAD} (which is conducted through transistor N4). As shown in FIG. 1, capacitors C1 and C2 can be coupled to the current mirror circuit (e.g., formed by transistor P6, P5, N5 and N6). Transistor N7 can have a gate coupled a gate of transistor N6 at a node 153 (which can have an associated voltage V_{CTL}). Capacitors C1 and C2 and transistor N7 can form part of a frequency compensation network (e.g., frequency compensation RC (resistor-capacitor)) network of control circuit 150. Control circuit 150 can be part of an open-loop control circuitry (which is different from (e.g., in addition to) open-loop control circuitries 173₁ and 173₂) of voltage regulator 101 that can operate to control the value of current I_{LOAD} at node 141.

As shown in FIG. 1, voltage regulator 101 can include a node (e.g., supply node) 192 to receive a voltage (e.g., supply voltage) V2. Voltages V2 and V1 can be provided by different voltages sources. The values of voltage V2 can be greater the value of voltage V1. Voltage regulator 101 can also include a node 123 to receive a voltage (e.g., reference voltage) V_{REF}. Node 123 can be coupled to an input node (at the gate of transistor P3) of comparator 135.

As shown in FIG. 1, voltage regulator 101 can include a circuit path (e.g., feedback path) 124 coupled to node 141 and the gate of transistor P4 of differential amplifier 120. Circuit path 124 and differential amplifier 120 can be part of a closed-loop (e.g., feedback loop) control circuitry of voltage regulator 101. Based on the signal (e.g., voltage or current) at node 141, the closed-loop control circuitry of voltage regulator 101 allows voltage regulator 101 to regulate the value of voltage V_{OUT} to keep it within a target value range.

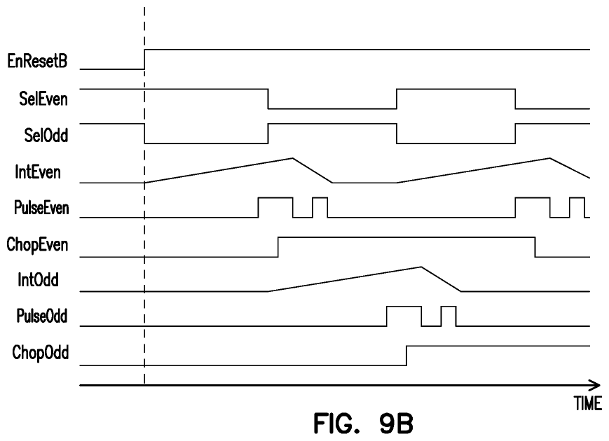

As shown in FIG. 1, voltage regulator 101 can include measurement circuitry 160, which can include a transistor N8 and a current sensor 161. Current sensor 161 can include nodes 162 and 163. Node 162 can be part of a current sense line that allows current sensor 161 to provide (e.g., generate) a current (e.g., sense current) I_{SENSE}. Transistor N8 can include a gate coupled to a gate of transistor N4, and terminal (e.g., source) coupled to node 141. Node 163 can be part of a voltage sense line that allows current sensor 161 to provide voltage (e.g., sense voltage) V_{SENSE}. Transistor N8 can conduct current I_{SENSE}. Transistor N8 can operate to allow control circuit 150 to generate current I_{SENSE} based on current I_{LOAD}. Transistor N8 can be structured based on the structure of transistor N4. For example, transistor N8 can be a replica of transistor N4. Physically, the size of transistor N8 can be much smaller than that of transistor N4. Thus, the value of current I_{SENSE} can be less than the value of current I_{LOAD}. The value of current (e.g., current I_{SENSE}) through transistor N8 relative to the value of current I_{LOAD} can be based on (e.g., the same as) the ratio of the device of transistor N4 and the size of transistor N8. Transistor N8 can have common source, drain, gate, and bulk voltage as transistor N4. Thus, transistor N8 can generate current I_{SENSE} based on current I_{LOAD} with a relatively high accuracy. As described in more detail below with reference to FIG. 9A and FIG. 9B, current I_{SENSE} is part of a measurement performed by measurement circuitry 160.

As described in more detail below with reference to FIG. 9A and FIG. 9B, measurement circuitry 160 can operate to measure a current (e.g., load current) I_{LOAD} of voltage regulator 101 to provide a current (e.g., sensed current) I_{SENSE} on node 162 based on current I_{LOAD}. Measurement circuitry 160 can generate information (e.g., digital information) based on current I_{SENSE}. The information can be used for power debug and the power management of silicon chip and other functions to improve operations of apparatus 100.

As shown in FIG. 1, voltage regulator 101 can include open-loop control circuitries 173₁ and 173₂. FIG. 1 shows two open-loop control circuitries 173₁ and 173₂ as an example. However, voltage at node 141 can be provided to fewer or more than two open-loop control circuitries, depending on the number of load circuits 103₁ and 103₂. In an apparatus, each open-loop control circuitry can be associated with a load circuit and located locally close to the load circuit. For example, as shown in FIG. 1, open-loop control circuitry 173₁ and load circuit 103₁ can be located close to each other (e.g., co-located) at a location 170₁. Open-loop control circuit 173₂ and load circuit 103₂ can be located close to each other (e.g., co-located) at a location 170₂. Open-loop control circuits 173₁ and 173₂ can be part of an open-loop control mechanism of voltage regulator 101 to allow voltage regulator 101 regulate the value of voltage V_{OUT} to keep it within a target value range.

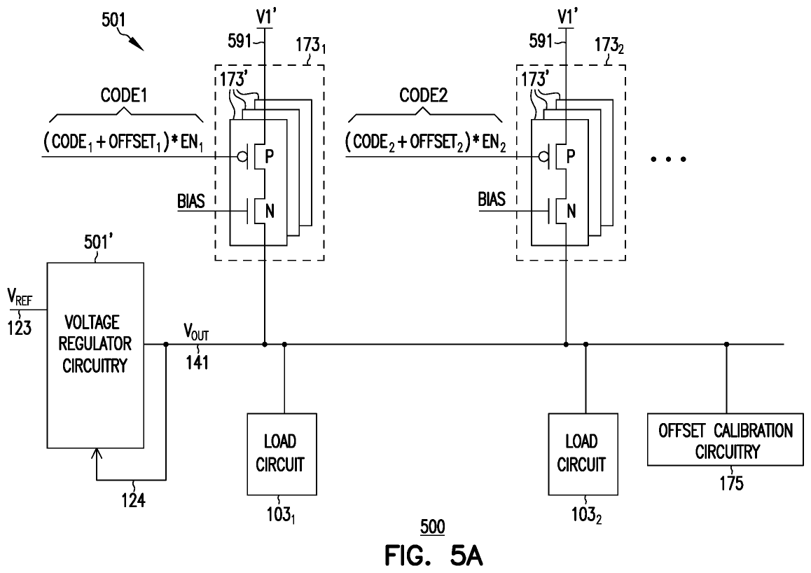

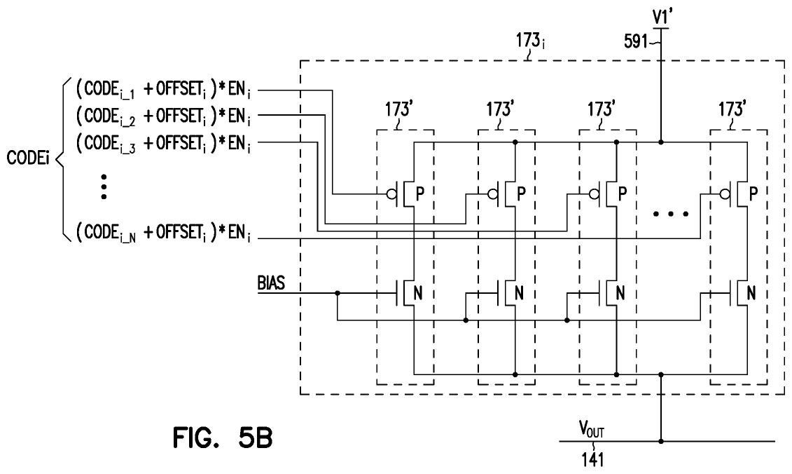

Voltage regulator 101 can include offset calibration circuitry 175. As described in more detail below with reference to FIG. 5A through FIG. 8D, calibration circuitry 175 can operate to provide offset information. Voltage regulator 101 can use the offset information to allow open-loop control circuitries 173₁ and 173₂ to improve control of the signal at node 141.

In FIG. 1, voltage regulator 101 can include two poles (dominant poles) at respective node 121 (e.g., output node of differential amplifier 120) and node 141 (e.g., output node of voltage regulator 101). Voltage regulator 101 can include a pole (non-dominant pole) at node 131 (e.g., output node of buffer 130). The location of the pole at node 141 can depend on a current (e.g., load current) I_{LOAD}. The pole at node 141 can be the primary pole when current I_{LOAD} is relatively low (e.g., near zero amperes). When current I_{LOAD} increases, the pole at node 141 moves towards the higher frequency region, and the pole at node 121 can eventually become the primary pole.

For stability, in general, the two poles at nodes 121 and 141 are designed to be located far away from each other. However, if the pole at node 121 is located at a much lower frequency than the frequency at node 141, the response time of voltage regulator 101 may be degraded. Thus, the pole at node 121 is designed to be located at a relatively higher frequency. However, locating the pole at node 121 at a high frequency can cause the pole at node 121 to be relatively close to the pole at node 141. This can impact the stability of voltage regulator 101. Therefore, voltage regulator 101 is structured to inject the zero to cancel of the pole to stabilize voltage regulator 101.

In order for voltage regulator 101 to be stable across a wide range of current I_{LOAD} (e.g., from 0 to 250 mA), the zero is injected such that it can cancel out the pole at node 141. Since the location of the pole at node 141 depends on current I_{LOAD}, the zero can be injected such that it can also track (e.g., sense) current I_{LOAD}. As shown in FIG. 1, transistor N5 can include a gate coupled with a gate of transistor N4, and a terminal (e.g., source) coupled to node 141. Transistor N5 can operate to conduct current I_{REP} based on current I_{LOAD} and track current I_{LOAD}. Transistor N5 can be structured based on the structure of transistor N4. For example, transistor N5 can be a replica of transistor N4. Physically, the size of transistor N5 can be much smaller than that of transistor N4. Thus, the value of current I_{REP} can be less than the value of current I_{LOAD}. The value of the current (e.g., current I_{REP}) through transistor N5 relative to the value of current I_{LOAD} can be based on (e.g., the same as) the ratio of the device of transistor N5 and the size of transistor N4. Transistor N5 can have common source, gate, and bulk voltage as transistor N4. Thus, current I_{REP} can be proportional to current I_{LOAD} in the first order. As shown in FIG. 1, transistor N5 is part of control circuit 150, which can operate (e.g., based on current I_{REP}) to allow to the frequency compensation network (e.g., formed at least in part by capacitor C1 and transistor N7) to adjust a location of zero in a control loop of voltage regulator 101. The frequency compensation network of control circuit 150 can also operate to disable zero in the control loop of voltage regulator 101 based on current I_{REP}, which is based on current I_{LOAD}, where current I_{LOAD} can be based on the capacitance at node 141.

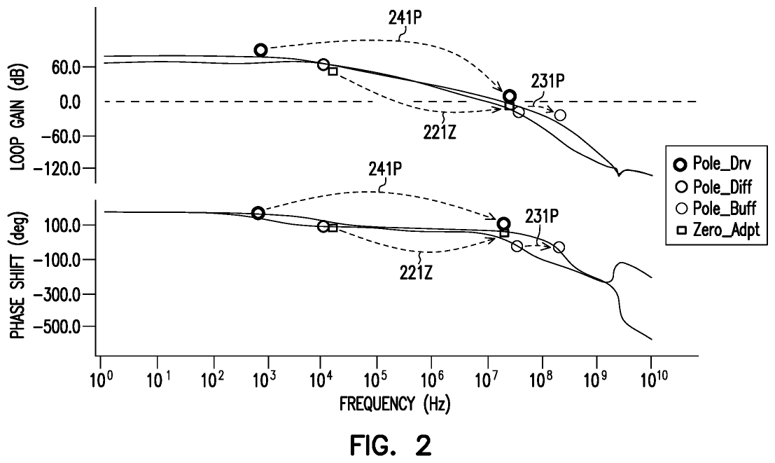

FIG. 2 shows an example Bode plot of open-loop frequency response of voltage regulator 101 across PVT, according to some embodiments described herein. The Bode plot in FIG. 2 shows how an example of how each the poles and zero move when the load current (e.g., current I_{LOAD}) increases (e.g., increases from 0 mA to 200 mA). In FIG. 2, legends Pole_Drv, Pole_Diff, and Pole Buff indicate respective poles at the output node (node 121) of differential amplifier 120, the output node (node 131) of buffer 130, and the output node (node 141) of voltage regulator 101. In FIG. 2, legend Zero_Adpt indicates the adaptive zero at the output node (node 121) of differential amplifier 120. As shown in FIG. 2, as current increases (e.g., from 0 mA to 200 mA), the poles Pole_Drv, Pole_ Diff, and Pole_Buff move (indicated by respective arrows 241P, 231P, and 221Z) and the zero Zero_Adpt can also move accordingly. The contribution of the adaptive zero (performed in part by control circuit 150) provides stability to voltage regulator 101. Control circuit 150 in voltage regulator 101 can also significantly improve the response time of voltage regulator 101. For example, in operation, when current I_{LOAD} increases suddenly, there may be some lag for the adaptive zero to be settled towards the steady state. During this small window between the sudden increase of current I_{LOAD} and the settlement of the adaptive zero, the gain and the bandwidth are boosted, which contributes to the faster response time of voltage regulator 101.

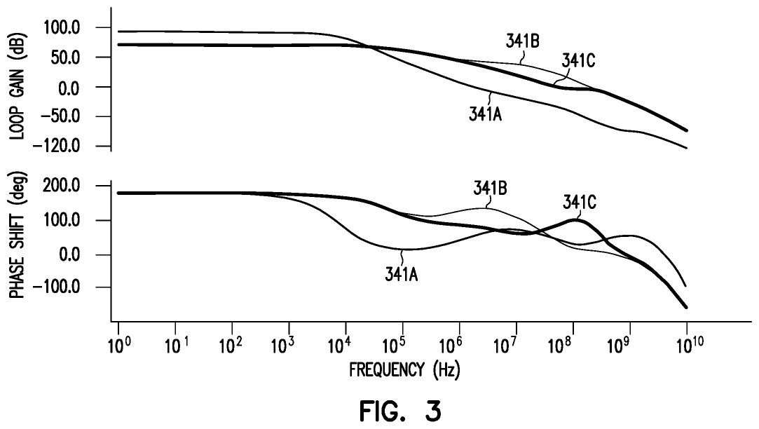

FIG. 3 shows the transition of the open-loop frequency response of voltage regulator 101, from the point where current I_{LOAD} suddenly increases from 0 to 100 mA, to the point where the adaptive zero is settled to the steady state, according to some embodiments described herein. In FIG. 3, curve 341A indicates the frequency response of voltage regulator 101 at the steady state (e.g., with current I_{LOAD}=0 mA). Curve 341B indicates the frequency response after (e.g., right after) current I_{LOAD} increases from 0 to 100 mA. Curve 341C indicates the frequency response after the adaptive zero is settled to the steady state.

As shown in FIG. 3, when the load current suddenly increases, the pole moves towards the higher frequency very quickly. However, the zero may not move as fast as that of the pole, and during this short window (e.g., before the settlement of the zero), the gain and the bandwidth are boosted (as shown with the yellow plot in FIG. 3). Although the performance improves, this short window may impact stability. Moreover, although the performance can further improve when the duration of this small window gets longer, impact on stability also increases. A worst-case scenario may occur when signal (voltage signal) V_{CTL} at a node 153 (FIG. 1) is not stable enough. For example, when signal V_{CTL} at node 153 significantly undershoots, the capacitive coupling between node 131 and node 121 in FIG. 1 significantly reduces, which results in instability. In order to prevent this scenario (e.g., failing scenario), capacitor (e.g., shunt capacitor) C2 is included in control circuit 150 to improve (e.g., increase) the capacitive coupling between node 131 and node 121 in FIG. 1 to maintain the stability of voltage regulator 101. The value of capacitor C2 can be relatively small (e.g., smaller than that of capacitor C1). The value of capacitor C1 can be selected such that the capacitive coupling between nodes 121 and 131 does not go lower than a certain threshold (e.g., a predetermined threshold value).

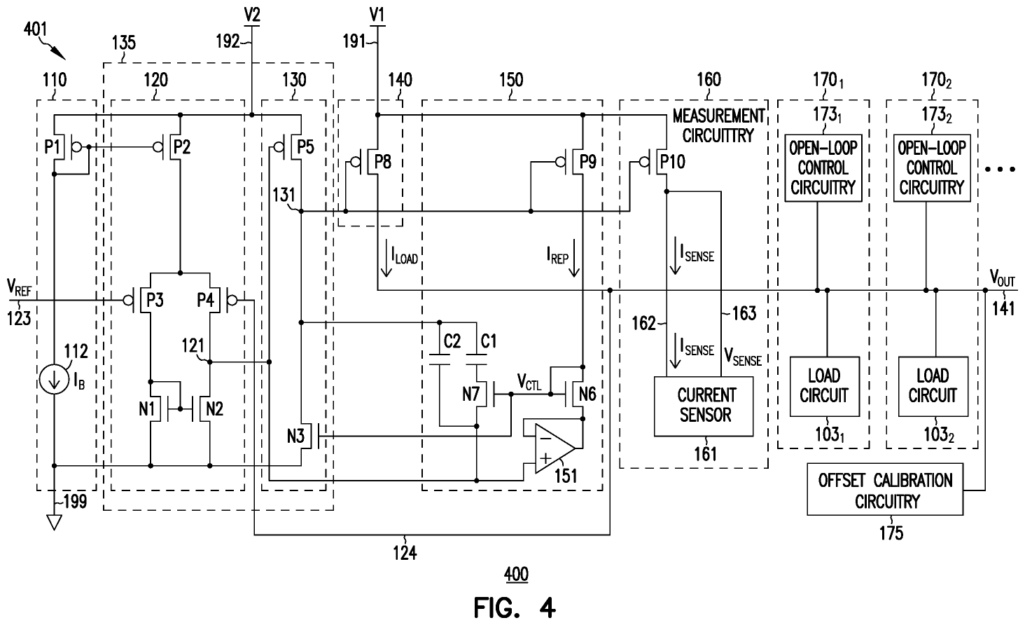

FIG. 4 shows an apparatus 400 including a voltage regulator 401, according to some embodiments described herein. Apparatus 400 and regulator 401 can include elements that are similar to or the same as some of the elements of voltage regulator 101. Thus, for simplicity, similar or the same elements in voltage regulators 101 and 401 are given the same labels and their descriptions are not repeated. Differences between voltage regulators 101 and 401 include transistors P8 and P9 in voltage regulator 401 and connections among the elements of voltage regulator 401 as shown in FIG. 4. In FIG. 1 (described above), driver 140 of voltage regulator 101 includes an NMOS transistor (e.g., transistor N4). In FIG. 4, driver 140 of voltage regulator 401 includes transistor P8, which is a PMOS transistor. Transistor P9, which is part of control circuit 150, is also a PMOS transistor. Voltage regulator 401 can have operating principles, improvements, and benefits similar to those of voltage regulator 101.

As shown in FIG. 4, voltage regulator 401 can include transistor P10 in measurement circuitry 160. Transistor P10 can operate to allow measurement circuitry 160 to generate current I_{SENSE} based on current I_{LOAD}. Transistor P10 can be structured based on the structure of transistor P8. For example, transistor P10 can be a replica of transistor P8. Physically, the size of transistor P10 can be much smaller than that of transistor P8. The ratio of the current (e.g., current I_{SENSE}) through transistor P10 can be based on (e.g., the same as) the ratio of the device of transistor P10 and the size of transistor P8. As described in more detail below with reference to FIG. 9A and FIG. 9B, current I_{SENSE} is part of a measurement performed by measurement circuitry 160.

In voltage regulator 101 (FIG. 1), since transistor N4 of driver 140 is an NMOS transistor, which has a relatively low output impedance, driver 140 can respond to a change (e.g., a sudden increase) in current I_{LOAD} relatively quickly. In voltage regulator 401, transistor P8 of driver 140 has a relatively high output impedance. Thus, driver 140 of voltage regulator 401 may have a slower response to a sudden change (e.g., a sudden increase) in current I_{LOAD} in comparison with that of driver 140 of voltage regulator 101. For example, when a voltage droop occurs at node 141 in FIG. 4, driver 140 of voltage regulator 401 may not respond until the voltage droop propagates through the feedback loop (which includes a loop from node 141 to differential amplifier 120 through circuit path 124 in FIG. 4). The connections between transistor N3 and other elements of voltage regulator 401 (which are different from the connections (e.g., adaptive biasing) between transistor N3 and other elements of voltage regulator 101 in FIG. 1) allow voltage regulator 401 to achieve a full benefit of the gain boosting mechanism when driver 140 of voltage regulator 401 includes a PMOS transistor (e.g., transistor P8). For example, the connections associated with transistor N3 in FIG. 4 can create a bypass path in the feedback loop that can significantly improve the response time of driver 140 of voltage regulator 401. This allows voltage regulator 401 to have similar benefit from the gain boosting mechanism as voltage regulator 101 of FIG. 1.

FIG. 5A shows an apparatus 500 including a voltage regulator 501 and open-loop control circuitries 173₁ and 173₂, and load circuits 103₁ and 103₂, according to some embodiments described herein. As mentioned above, an open-loop branch is often included in a LDO voltage regulator to suppress high frequency voltage droop. The open-loop branch can enhance the response time of the LDO voltage regulator if AC noise is faster than what the feedback loop of the LDO voltage regulator can support and if the AC noise profile can be predicted in advance. Due to the open-loop nature, the open-loop branch can achieve much faster response time than that of the feedback loop of the LDO voltage regulator. However, an open-loop branch may not have good control on the DC voltage, which often needs to be corrected by the feedback loop of the LDO voltage regulator that runs in parallel the open-loop branch. For some applications, the open-loop branch may handle 90% of the total load current, while the feedback loop of the LDO voltage regulator also runs (in parallel with the feedback loop) to correct the DC error that the open-loop branch induced. However, this approach often needs the open-loop branch to have reasonably good DC voltage control.

As described in more detail below, voltage regulator 501 includes offset calibration circuitry 175 to allow open-loop control circuits 173₁ and 173₂ of voltage regulator 501 to achieve accurate DC voltage control with minimal help from the feedback loop of voltage regulator 501. The accuracy of the noise profile calibration provided by offset calibration circuitry 175 can directly impact performance of voltage regulator 501. In an example, open-loop control circuits 173₁ and 173₂ can be suitable for voltage regulation of the power supply rail of the clock generation and the phase interpolation circuits because it is relatively easy to predict how the clocking circuit and its load current behave as a sequence in advance.

As shown in FIG. 5A, voltage regulator 501 can include voltage regulator circuitry 501′ and circuit path 124. Voltage regulator circuitry 501′ can include part of either voltage regulator 101 or voltage regulator 401. For example, voltage regulator 501 can include voltage regulator 101 of FIG. 1 except for measurement circuitry 160, open-loop control circuitries 173₁ and 173₂ and offset calibration circuitry 175 of FIG. 1. Circuit path 124 in FIG. 5A can correspond to circuit path 124 of voltage regulator 101 or voltage regulator 401.

As shown in FIG. 5A, voltage regulator 501 can include a node (e.g., supply node) 591 to receive voltage (e.g., supply voltage) V1′. Voltage V1′ can have the same value as voltage V1 of FIG. 1.

As shown in FIG. 5A, open-loop control circuitry 173₁ can include circuit paths 173′ coupled in parallel with each other between node 591 and node (e.g., output node) 141 of voltage regulator 501. Similarly, open-loop control circuitry 173_{2 1} can include circuit paths 173′ coupled in parallel with each other between node 591 and node 141.

Each circuit path 173′ can include transistors P and N coupled between supply node 591 and node 141. For simplicity, transistors P and N are shown in only one of circuit paths 173′ of open-loop control circuitry 173₁ and one of circuit paths 173′ of open-loop control circuitry 173₂.

As shown in FIG. 5A, open-loop control circuitries 173₁ and 173₂ can include nodes (at the gates of transistors N) to receive respective bias information (e.g., bias voltage signals) BIAS. Bias information BIAS can be used to control the amount of current through open-loop control circuitries 173₁ and 173₂.

As shown in FIG. 5A, open-loop control circuitry 173₁ can include nodes (e.g., at the gates of transistors P) in respective circuit path 173′ of open-loop control circuitry 173₁ to receive respective code information (e.g., bits) that includes (CODE₁+OFFSET₁)*EN₁. For simplicity, code information (CODE₁+OFFSET₁)*EN₁ is also called CODE1 (as shown in FIG. 5A). CODE1 can be used to control (e.g., selectively turn on or turn off) transistors P in open-loop control circuitry 173₁. As shown in FIG. 5A, CODE1 can be a combination of a portion CODE₁ and a portion OFFSET₁.

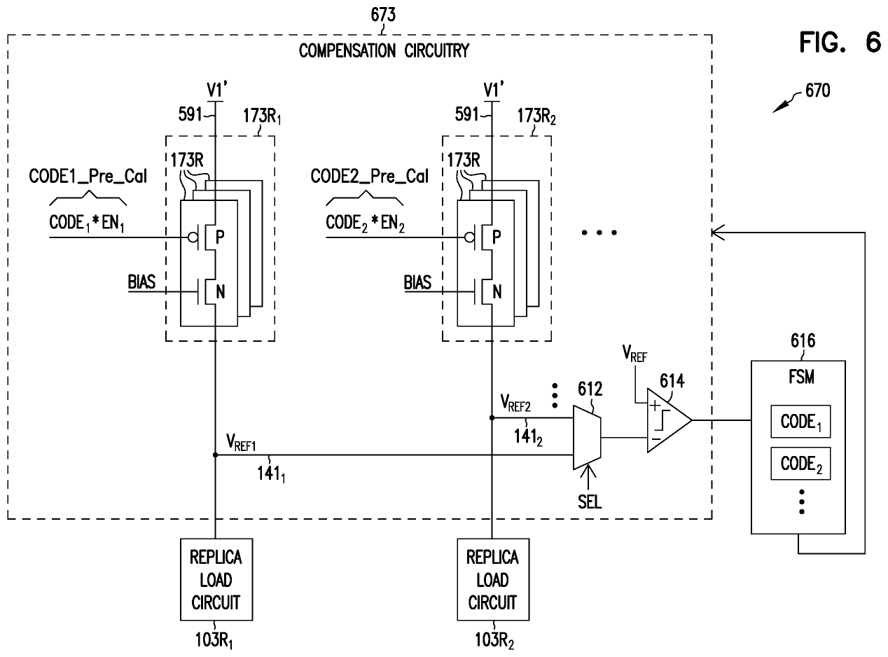

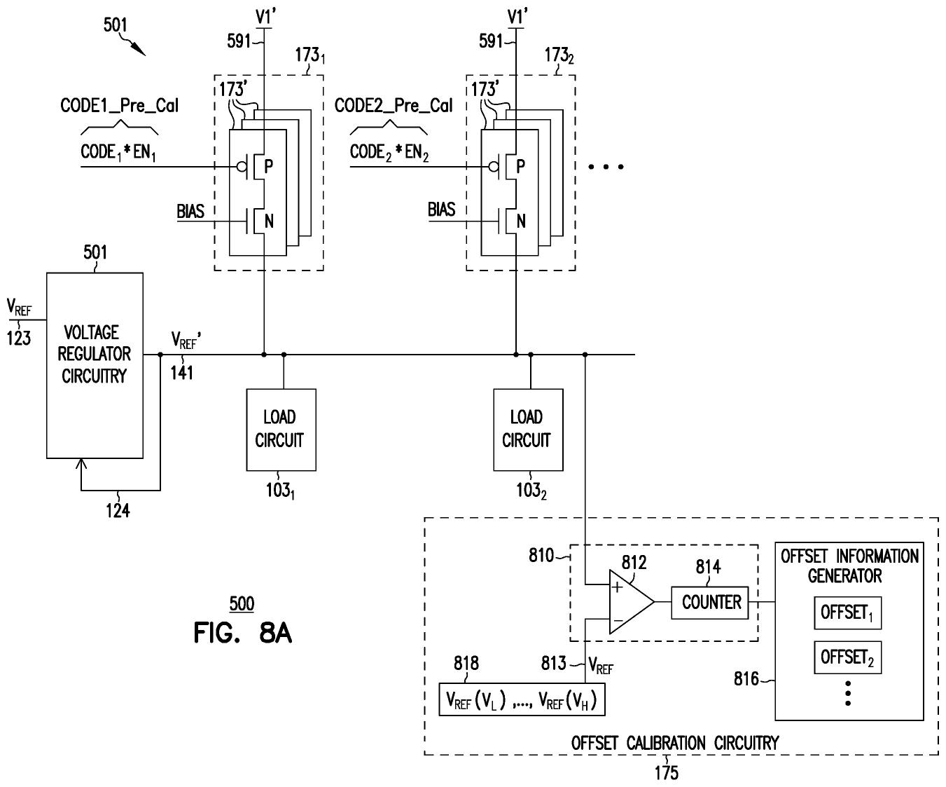

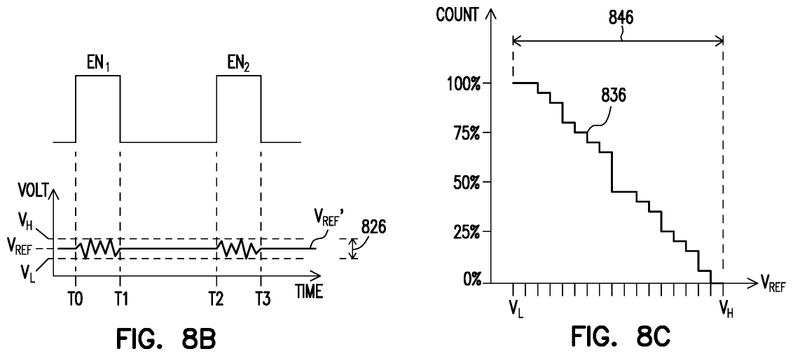

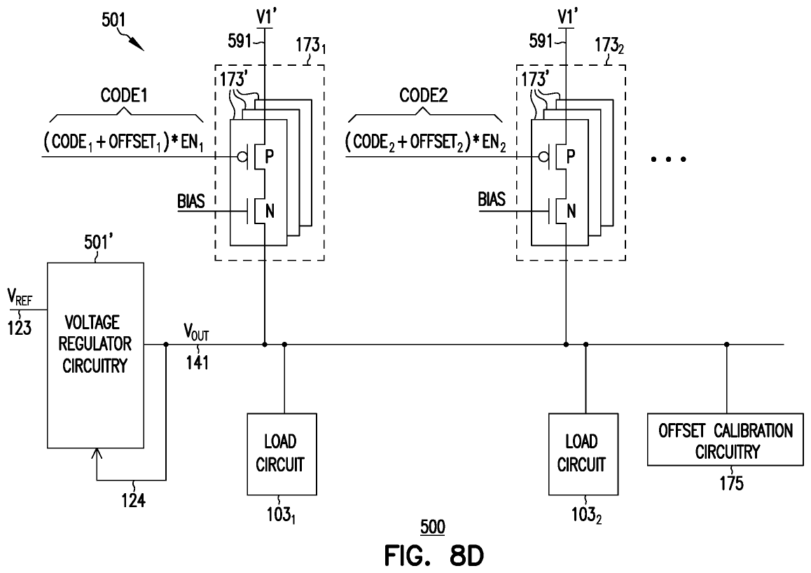

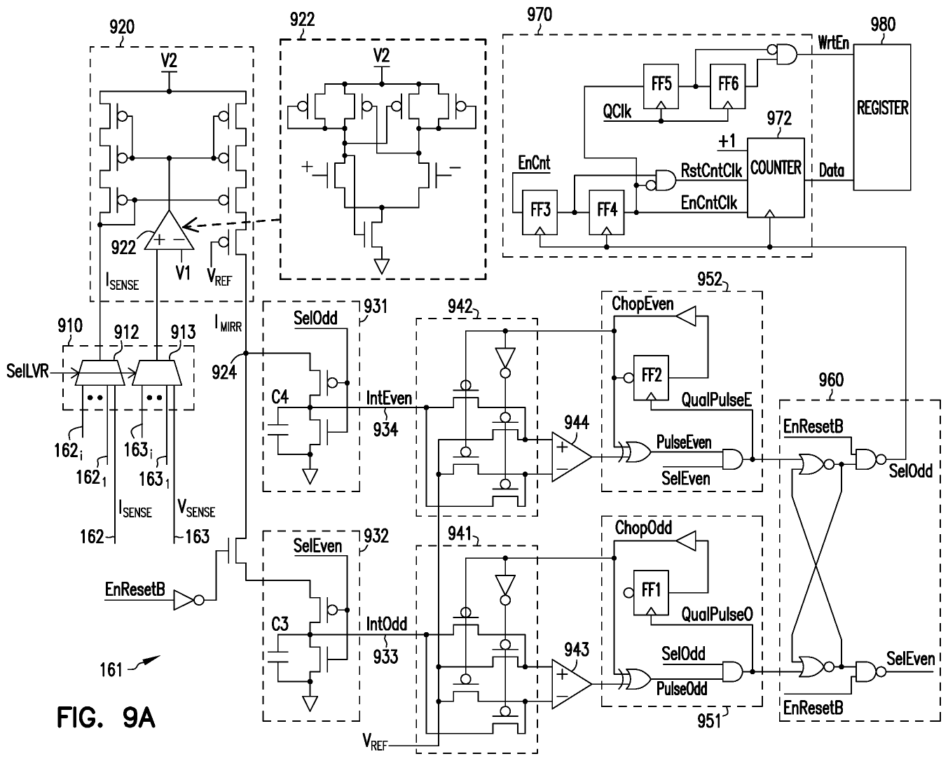

Similarly, open-loop control circuitry 173₂ can include nodes (e.g., at the gates of transistors P) in respective circuit path 173′ of open-loop control circuitry 173₂ to receive respective code information (e.g., bits) that includes (CODE₂+OFFSET₂)*EN₂. For simplicity, code information (CODE₂+OFFSET₂)*EN₂ is also called CODE2 (as shown in FIG. 5A). CODE2 can be used to control (e.g., selectively turn on or turn off) transistors P in open-loop control circuitry 173₂. As shown in FIG. 5A, CODE2 can be a combination of a portion CODE₂ and a portion OFFSET₂. As described in more detail below, portions CODE₁ and CODE₂ can be obtained based on an operation (e.g., a compensation operation) associated with FIG. 6. Portions OFFSET₁ and OFFSET₂ can be obtained based on an operation (e.g., a calibration operation) associated with FIG. 8A through FIG. 8D.

FIG. 5B shows details of open-loop control circuitry 173ᵢ that represents one of open-loop control circuitries 173₁ and 173₂ of FIG. 5A, according to some embodiments described herein. Circuit path 173′ in FIG. 5B represents (e.g., corresponds to) one of circuit path 173′ in FIG. 5A. In FIG. 5B, information (CODE_{i_1}+OFFSETᵢ)*EN₁ through information (CODE_{i_N}+OFFSETᵢ)*ENᵢ can be called CODEi (code information). In FIG. 5B, CODEi represents CODE1 or CODE2 of FIG. 5A. CODEi can include bits (e.g., N bits) associated with information (CODE_{i_1}+OFFSETᵢ)*EN₁ through information (CODE_{i_N}+OFFSETᵢ)*ENᵢ. For example, information (CODE_{i_1}+OFFSETᵢ)*EN₁ can be associated with (e.g., can represent) a bit of CODEi. Information (CODE_{i_2}+OFFSETᵢ)*EN₁ can be associated with (e.g., can represent) another bit of CODEi, and so on.

In FIG. 5B, each circuit path 173′ can form a circuit path (e.g., current path) between nodes 591 and 141 when it is activated. A particular circuit path 173′ is activated based on the value bias information BIAS and a respective bit of CODEi. For example, circuit path 173′ coupled to information (CODE_{i_1}+OFFSETᵢ)*EN₁ can be activated (e.g., turn on) based on one value (e.g., a value corresponding to logic zero) of information (CODE_{i_1}+OFFSETᵢ)*EN₁ and based on bias information BIAS having value to turn on transistor N. In another example, circuit path 173′ coupled to information (CODE_{i_1}+OFFSETᵢ)*EN₁ can be deactivated (e.g., turn off) based on another value (e.g., a value corresponding to logic one) of information (CODE_{i_1}+OFFSETᵢ)*EN.

Open-loop control circuitry 173ᵢ can be associated with a respective load circuit, such as load circuit 103₁ or 103₂ of FIG. 5A. Circuit paths 173′ of open-loop control circuitry 173ᵢ can be controlled to be activated (or deactivated) based on the value of signal (e.g., voltage or current) at node 141. The value of the signal on node 141 can be based on operating condition of the load circuit coupled to node 141. Control circuit 173i can provide stability to voltage regulator 501, as described below.

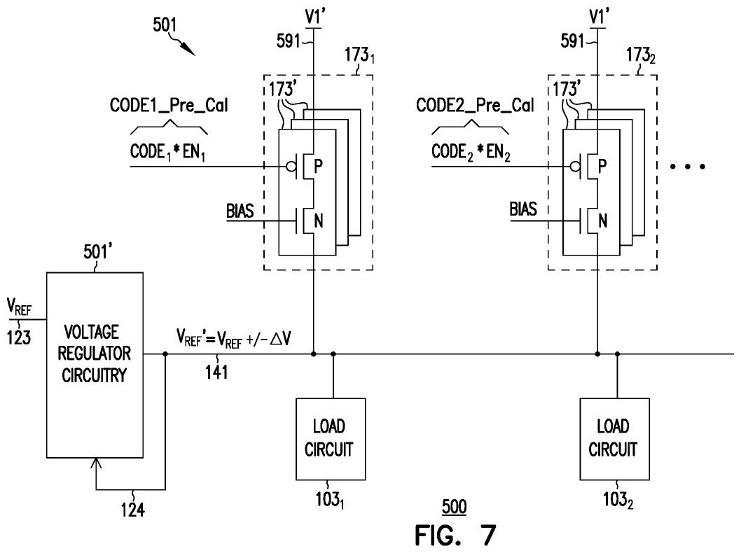

The value of CODEi (e.g., CODE1 or CODE2 in FIG. 5A) can be selected (e.g., predetermined) based on operating condition of the load circuit (e.g., co-located load circuit) associated with open-loop control circuitry 173ᵢ. The value of CODEi (e.g., CODE1 or CODE2 in FIG. 5A) can be selected by a compensation operation (associated with FIG. 6) and a calibration operation (associated with FIG. 7 and FIG. 8A through FIG. 8D).

FIG. 6 shows a code generator 670 including compensation circuitry 673, according to some embodiments described herein. Code generator 670 can also a finite state machine (FSM) 616, and include replica load circuits 103R₁ and 103R₂. The structures of replica load circuits 103R₁ and 103R₂ can be based on the structures of load circuits (actual load circuits) 103₁ and 103₂, respectively, of FIG. 5A. For example, replica load circuits 103R₁ and 103R₂ can be replicas (e.g., models) of load circuit 103₁ and 103₂, respectively, of FIG. 5A. As shown in FIG. 6, compensation circuitry 673 can include open-loop control circuitries 173R₁ and 173R₂ that have structures based on the structures of open-loop control circuitries (actual open-loop control circuitries) 173₁ and 173₂, respectively, of FIG. 5A. For example, open-loop control circuitries 173R₁ and 173R₂ can be replicas (e.g., models) of open-loop control circuitries 173₁ and 173₂, respectively, of FIG. 5A. As shown in FIG. 6, compensation circuitry 673 can include a selector (e.g., multiplexer) 612 and a comparator 614.

Compensation circuitry 673 can operate to provide (e.g., generate) code information CODE₁*EN₁ and CODE₁*EN₂ for open-loop control circuitries 173R₁ and 173R₂, respectively. For simplicity, code information CODE₁*EN₁ and CODE₁*EN₂ can be called CODE1_PreCal and CODE2_PreCal (pre-calibrated code information). After the compensation operation associated with FIG. 6, CODE1_PreCal and CODE2_PreCal are provided to open-loop control circuitries 173₁ and 173₂ of voltage regulator 501 (FIG. 1). Then, a calibration operation (associated with FIG. 7 and FIG. 8A through FIG. 8D) can be performed to provide respective offset information (e.g., OFFSET1 and OFFSET2 in FIG. 8A). The offset information can be incorporated into (e.g., combined with) respective CODE CODE1_PreCal and CODE2_PreCal to further improve open-loop control of voltage regulator 501 (FIG. 5A).

FIG. 6 shows two open-loop control circuitries 173R₁ and 173R₂ and two associated replica load circuits 102R₁ and 103R₂ as an example. However, the number of open-loop control circuitries 173R₁ and 173R₂ and the number of associated replica load circuits 102R₁ and 103R₂ are based on the number of open-loop control circuitries 173₁ and 173₂ (FIG. 5A) and the number of associated load circuits 102₁ and 103₂ (FIG. 5A), respectively.

In operation, selector 612, in response to selection information SEL, can select nodes 141₁ and 141₂ one at time (one by one) for the generation of particular code information for selected open-loop control circuitry until code information are generated for all of open-loop control circuitries (e.g., open-loop control circuitries 173R₁ and 173R₂) of compensation circuitry 673. In FIG. 6, each of voltage V_{REF1} and V_{REF2} on nodes node 141₁ and 141₂, respectively, can represent voltage V_{OUT} at node 141 of FIG. 5A. In FIG. 6, comparator 614 and FSM 616 can operate to adjust the value CODE1_PreCal until voltage V_{REF1} is equal to voltage V_{REF}. Comparator 614 and FSM 616 can operate to adjust the value CODE2_PreCal until voltage V_{REF2} is equal to voltage V_{REF}. The compensation operation is completed after the code information for the open-loop control circuitries (e.g., open-loop control circuitries 173R₁ and 173R₂) of compensation circuitry 673 are adjusted (e.g., after each of voltages V_{REF1} and Verf2 is equal to voltage V_{REF}).

FIG. 7 shows an example voltage variation +/−ΔV (+/−delta V) at node (e.g., output node) 141 of voltage regulator 501 of FIG. 5A using code information provided from the compensation operation associated with FIG. 6, according to some embodiments described herein. In FIG. 7, although CODE1_PreCal and CODE2_PreCal at open-loop control circuitries 173₁ and 173₂, respectively, are adjusted in the compensation operation associated with FIG. 6, voltage V_{REF}′ at node 141 may deviate from a target (e.g., expected) voltage V_{REF} by an amount of voltage indicated by +/− (plus or minus) delta V. When load circuits 103₁ and 103₂ are not operating (e.g., idle), voltage regulator 501 can keep voltage V_{REF1} at node 194 at voltage V_{REF}. However, when load circuits 103₁ and 103₂ are operating, a relatively high di/dt (current as a function of time) noise may occur at node 141 since load circuits 103₁ and 103₂ may be operating at a relatively high speed. Voltage regulator 501, in some situations, may also be unable to properly track such noise due to lower bandwidth. Thus, as shown in FIG. 7, a difference (indicated by +/−delta V) may exist between voltage V_{REF}′ and voltage V_{REF} if the value of the code information (e.g., CODE1_PreCal and CODE2_PreCal) provided to open-loop control circuitry 173₁ or 173₂ is inaccurate. The inaccuracy in the value of the code information may be attributed to differences between replica load circuits 103R₁ and 103R₂ (FIG. 6) and load circuits (actual load circuits) 103₁ and 103₂, respectively, of FIG. 7. Such differences may include variations in PVT conditions, random variation, and other variations.

FIG. 8A shows voltage regulator 501 of apparatus 500 of FIG. 5A and offset calibration circuitry 175, according to some embodiments described herein. As described below, offset calibration circuitry 175 can operate to provide offset information to correct systematic/random offset error of the power supply that may be induced by open-loop control circuitry 173₁ or 173₂. The offset information can be combined with other control information (e.g., code information) in a one-time offset correction. In an example, firmware can be used to perform the one-time offset correction based on a voltage sensing operation performed by offset calibration circuitry 175. As described below, offset calibration circuitry 175 of FIG. 5A can include an on-chip voltage sensor (e.g., voltage sensor 810 of FIG. 8A) to perform the voltage sensing as part of the offset correction. As described below, one of the inputs (e.g., input nodes) of the voltage sensor (e.g., a comparator) can be coupled to the output node (node 141) of voltage regulator 501 and the other input (e.g., input node) of the voltage sensor can be swept to either measure the peak-to-peak noise or create a histogram for the voltage (e.g., voltage V_{OUT}) at node 141 of voltage regulator 501.

During the calibration, the sequence of the clocking operations may run (e.g., phase clock spine, followed by phase enable, followed by phase interpolation, etc.) while recording the voltage profile by the voltage sensor (e.g., voltage sensor 810 of FIG. 8A). The voltage sensor can capture the AC noise profile by creating a histogram or a complete cumulative distribution function (CDF) using a counter (e.g., counter 814), where the reference voltage (V_{REF}) is swept while measuring voltage sensor count for each point (as shown in FIG. 8C). The AC noise can be defined by the difference in the 0% and the 100% points in the CDF plot shown in FIG. 8C.

Offset calibration circuitry 175 can operate to reduce the difference (indicated by +/−delta V) that may exist between voltage V_{REF}′ and voltage V_{REF} shown in FIG. 7. Offset calibration circuitry 175 can provide (e.g., generate) offset information (e.g., correction information) OFFSET1 and OFFSET2. For simplicity, offset information OFFSET1 and OFFSET2 can be simply called OFFSET1 and OFFSET2, respectively (without the term “offset information”). After OFFSET1 and OFFSET2 are generated, they can be incorporated (e.g., combined) with respective CODE1_PreCal and CODE2_PreCal to provide code information (e.g., corrected code information) CODE1 and CODE2 (as shown in FIG. 5A or FIG. 8D) to further improve open-loop control of voltage regulator 501 (FIG. 5A or FIG. 8D). FIG. 8A shows two offset information, OFFSET1 and OFFSET2, as an example. However, the number of offset information can be based on the number of code information CODE1_PreCal and CODE2_PreCal associated with the number of open-loop control circuitries 173₁ and 173₂.

As shown in FIG. 8A, offset calibration circuitry 175 can include voltage sensor 810, an offset information generator 816, and a voltage generator 818. Voltage sensor 810 can include a comparator 812 and a counter (digital counter) 814. Voltage sensor 810 can be an on-chip voltage sensor that can be included in the same chip as voltage regulator 501. Comparator 812 can include a flash-like sampling analog-to-digital converter (ADC).

In operation, load circuits 103₁ and 103₂ can be turned on one by one. The order (e.g., priority) of which load circuits 103₁ and 103₂ can be turned on can be based on the IC functionality. For example, if load circuit 103₁ feeds a clock signal to load circuit 103₂, then load circuit 103₁ can be turned on to generate OFFSET1. Then, the load circuit 103₂ can be turned on (while load circuit 103₁ remains turned-on) on to generate OFFSET2.

As an example, load circuit 103₁ can be activated between times T0 and T1 in FIG. 8B based on activation of a signal (e.g., enable signal) EN₁. Load circuit 103₂ can be activated between times T2 and T3 (FIG. 8B) based on activation of a signal (e.g., enable signal) EN₂. In this example, load circuit 103₁ can remain activated while load circuit 103₂ is activated between times T2 and T3. In FIG. 8B, voltage V_{REF}′ corresponds to voltage V_{REF}′ on node 141 of voltage regulator 501 of FIG. 8A. Between times T0 and T1 in FIG. 8B, voltage V_{REF}′ corresponds to voltage V_{REF}′ on node 141 of FIG. 8A while load circuit 103₁ is turned on. Between times T2 and T3 in FIG. 8B, voltage V_{REF}′ in FIG. 8B corresponds to voltage V_{REF}′ on node 141 of FIG. 8A while load circuits 103₁ and 103₂ are turned on.

As shown in FIG. 8B, voltage V_{REF}′ can vary (e.g., due to noise) along a voltage range 826, which can have a lower voltage V_{L} (e.g., lower limit) and a higher voltage V_{H} (e.g., higher limit). Offset calibration circuitry 175 of FIG. 8A can operate to provide (e.g., generate) offset information to correct (e.g., reduce) variation in voltage V_{REF}′.

As shown in FIG. 8A, comparator 812 of voltage sensor 810 can include an input (e.g., input node) coupled to node 141 of voltage regulator 501, and a node (e.g., input node) 813 coupled to voltage generator 818. Voltage sensor 810 can operate to capture AC noise profile voltage V_{REF}′ by sweeping voltage V_{REF} at node 813 and generate a histogram or a CDF using counter 814. In an operation, comparator 812 of voltage sensor 810 can compare a voltage node 141 with voltage V_{REF} at node 813 and provide result information that can be used by offset information generator 816 to generate OFFSET₁ and OFFSET₂. In FIG. 5A, portions OFFSET₁ and OFFSET₂ of CODE1 and CODE2, respectively, are provided by the calibration operation performed by offset calibration circuitry 175 of FIG. 8A.

In FIG. 8A, voltage generator 818 can generate a number of voltages (varying voltages) that can have values varied by +/−delta V from voltage V_{REF}. FIG. 8C shows the number of counts 836 within voltage range 846 that can correspond to voltage range 826 of FIG. 8B. When voltage V_{REF} at node 813 is completely below the noisy voltage V_{REF}′ at node 141, the output of the voltage sensor 810 (e.g., the output node comparator 812) can be all 1s (100% of bits correspond to logic one) for the period that offset calibration circuitry 175 measures voltage V_{REF}′. In FIG. 8C, all 1s is denoted by 100%.

When voltage V_{REF} at node 813 is close to (or in the middle of) the noisy voltage V_{REF}′ at node 141, the output of the voltage sensor 810 (e.g., the output node comparator 812) can be 50% 1s (50% of the bits corresponds to logic one) and 50% 0s (50% of the bits corresponding to logic zero) depending on the value of voltage V_{REF} at node 813 for the period that offset calibration circuitry 175 measure voltage V_{REF}′. In FIG. 8C, 50% 1s and 50% 0s is denoted by 50%.

When voltage V_{REF} at node 813 is completely above the noisy voltage V_{REF}′ at node 141, the output of the voltage sensor 810 (e.g., the output node comparator 812) can be all 0s (100% of bits corresponds to logic zero) for the period that offset calibration circuitry 175 measure voltage V_{REF}′. In FIG. 8C, all 0s is denoted by 0%. The peak-to-peak noise of voltage V_{REF}′ is denoted by the difference between V_{REF}, 0% (V_{H}) and V_{REF}, 100% (V_{L}).

As described above, the operation of offset calibration circuitry 175 can provide offset information OFFSET1 and OFFSET2, which can be incorporated into respective CODE1_PreCal and CODE2_PreCal (FIG. 8A) to provide CODE1 and CODE2, respectively, as shown in FIG. 8D. Using CODE1 and CODE2 can further improve open-loop control of voltage regulator 501 (FIG. 5A), as described above.

FIG. 9A shows details of current sensor 161 of FIG. 1 or FIG. 4, according to some embodiments described herein. FIG. 9B is a timing diagram showing waveforms for some of the signals of current sensor 161 of FIG. 9B. Current sensor 161 can be shared between multiple voltage regulators, which can be similar to voltage regulator 101 of FIG. 1 or voltage regulator 401 of FIG. 4. Current sensor 161 can provide current-to-digital conversion, as described below.

As shown in FIG. 9A, current sensor 161 can include a selector circuit 910, which can include multiplexers 912 and 913, to allow sharing of current sensor 161. Signal SelL VR can be used to select a particular voltage regulator (e.g., voltage regulator 101) among the voltage regulators for current measurement.

Node 162₁ at the input of multiplexer 912 can correspond to node 162 of FIG. 1 or FIG. 4. Node 162ᵢ at the input of multiplexer 912 can correspond to other nodes 162 (not shown) of other voltage regulators (not shown) similar to voltage regulator 101 of FIG. 1 or voltage regulator 401 of FIG. 4. Node 163₁ at the input of multiplexer 912 can correspond to node 163 of FIG. 1 or FIG. 4. Node 163ᵢ at the input of multiplexer 912 can correspond to other nodes 163 (not shown) of other voltage regulator (not shown) similar to voltage regulator 101 of FIG. 1 or voltage regulator 401 of FIG. 4.

In FIG. 9A, voltage regulator 101 (or voltage regulator 401) can send a fraction of load current (e.g., I_{LOAD} in FIG. 1) in the form of current I_{SENSE} at node 162₁. Voltage regulator 101 (or voltage regulator 401) can send voltage V_{SENSE} to node 163₁. Voltage V_{SENSE} at node 163 can reduce mirroring inaccuracy of load current I_{LOAD} that may be due to a voltage drop (IR drop) created by long route from a voltage regulator (e.g., voltage regulator 101) to current sensor 161. As shown in FIG. 9A, current sensor 161 can include a double-cascode circuit 920 with an op-amp 922 that can be used to improve resistance Rout at the output of op-amp 922 and provide accurate current mirroring (indicated by current I_{MIRR} at a node 924) across a wide common mode range. Current (e.g., mirrored current) I_{MIRR} is then integrated across one of the two capacitors C3 and C4 of integrators 931 and 932, respectively. The time-interleaved capacitors C3 and C4 charge/discharge in a ping-pong fashion to register the corresponding comparator output at the output node of comparator 943 or the output node of comparator 944 when it (node 933 or node 934) reaches a certain reference voltage (e.g., voltage V_{REF}).

Comparator offset can be cancelled using a respective chopper circuit 941 or 942, which can be configured (when chop is enabled) to swap the inputs of comparators 943 and 944 between IntEven (or IntOdd) and V_{REF} at each cycle, so that the comparator offset is cancelled to the first order. If chop is disabled, one input (e.g., input node) of the comparators 943 and 944 can be fixed to V_{REF} and the other input (e.g., input node) can be fixed to IntEven (or IntOdd). Circuits 951 and 952 receive the output from respective comparators 943 and 944 output as input and generate respective pulses that are provided to a RS latch (Set-Reset latch) 960. RS latch 960 selects the appropriate integrator (e.g., integrators 931 or 932) and produces an asynchronous output clock (SelOdd or SelEven) whose frequency is proportional to the current I_{SENSE} on line 162. This clock (SelOdd or SelEven) controls a counter 972 of circuit 970. Circuit 970 integrates the current I_{MIRR} over a long period of time and represents the current I_{SENSE}.

In FIG. 9A, EnCnt in circuit 970 is asserted when current sensor 161 is enabled for measurement. After being conditioned by SelOdd and QClk, EnCnt becomes WrtEn, which enables a register 980 to store the output of the counter 972. Output from register 980 (which represents the sensed current I_{SENSE}) can be used for power debug, power management, or other applications to improve or analyze operations and performance of the IC chip that includes the voltage regulator (e.g., voltage regulator 101 or voltage regulator 401).

The following section describes functions of some of the signals shown in FIG. 9A and FIG. 9B.

EnResetB: current sensor 161 starts sensing after the EnResetB is asserted.

PulseOdd/PulseEven: PulseOdd (PulseEven) toggles to a higher level when IntOdd (IntEven) in FIG. 9B crosses V_{REF} (e.g., when the output nodes of comparators 943 and 944 in FIG. 9A toggles high), and toggles back to a lower level again after the signal propagates through flip-flop FF1 (FF2) and buffer back to the input of logic gate XOR in circuit 952, generating a pulse.

ChopOdd/ChopEven: ChopOdd/ChopEven toggles at half the frequency of the SelOdd/SelEven (whose frequency is proportional to current ISENSE) as shown in FIG. 9B, and after being qualified by a logic gate (e.g., AND gate, not shown to reduce complexity). ChopOdd/ChopEven toggles chopper circuits 941 and 942 (FIG. 9A) at the input nodes of comparators 943 and 944 to cancel offset to the first order when chopping feature is enabled.

QualPulseO/QualPulseE: QualPulseO (QualPulseE) node toggles from a lower level to a higher level when both SelOdd (SelEven) and PulseOdd (PulseEven) are at a higher level, which toggles the output nodes of RS latch 960 and ChopOdd (ChopEven) at the output of flip-flop FF1 (FF2), and eventually goes back to 0 when SelOdd (SelEven) goes back to 0.

EnCnt: EnCnt is asserted when current sensor 161 is enabled for debug purposes.

QClk: QClk is clock signal (e.g., a clock signal in a SoC) that is used for digital circuits (e.g., including part of current sensor 161).

RestCntClk: RstCntClk is used to reset counter 972 before starting a new current measurement.

V_{REF} is a stable voltage, which can be generated internally in the voltage regulator (e.g., voltage regulator 101 (FIG. 1) or voltage regulator 401 (FIG. 4) or current sensor 161 (FIG. 9A).

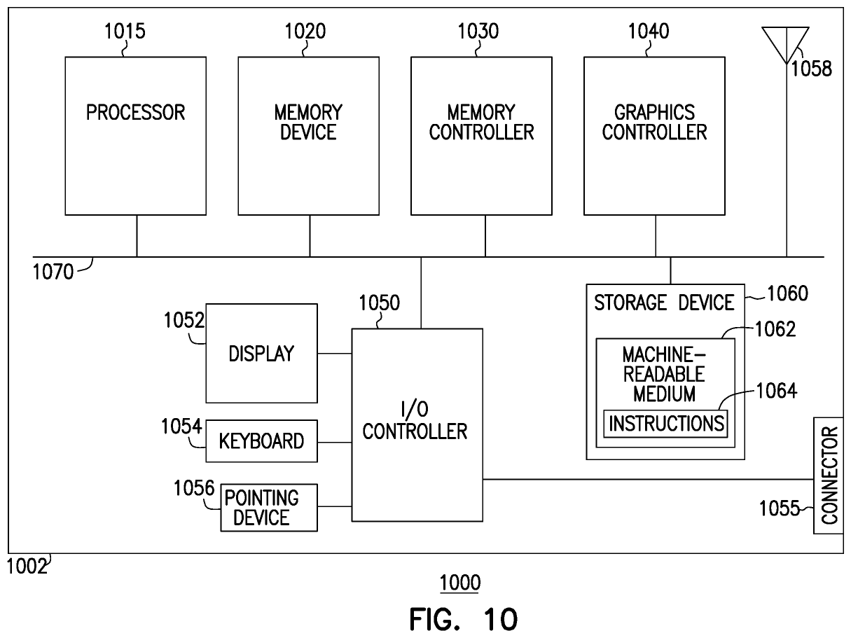

FIG. 10 shows an apparatus in the form of a system (e.g., electronic system) 1000, according to some embodiments described herein. System 1000 can be viewed as a machine. System (e.g., machine) 1000 can include or be included in a computer, a cellular phone, or other electronic systems. As shown in FIG. 10, system 1000 can include components (e.g., devices) located on a circuit board (e.g., printed circuit board (PCB)) 1002. The components can include a processor (e.g., a hardware processor) 1015, a memory device 1020, a memory controller 1030, a graphics controller 1040, an input/output (I/O) controller 1050, a display 1052, a keyboard 1054, a pointing device 1056, at least one antenna 1058, a storage device 1060, and a bus 1070. Bus 1070 can include conductive lines (e.g., metal-based traces on a circuit board 1002 where the components of system 1000 are located).

System 1000 may be configured to perform one or more of the methods and/or operations described herein. System 1000 or at least one of the components of system 1000 (e.g., at least one of processor 1015, memory device 1020, memory controller 1030, graphics controller 1040, and I/O controller 1050) can include at least part of the apparatuses described herein (e.g., voltage regulator 101, 401, or 501).

In FIG. 10, processor 1015 can include a general-purpose processor or an application specific integrated circuit (ASIC). Processor 1015 can include a CPU and processing circuitry. Graphics controller 1040 can include a GPU and processing circuitry. Memory device 1020 can include a dynamic random-access memory (DRAM) device, a static random-access memory (SRAM) device, a flash memory device, phase change memory, or a combination of these memory devices, or other types of memory. FIG. 10 shows an example where memory device 1020 is a stand-alone memory device separated from processor 1015. In an alternative structure, memory device 1020 and processor 1015 can be located on the same IC chip (e.g., a semiconductor die or IC die). In such an alternative structure, memory device 1020 is an embedded memory in processor 1015, such as embedded DRAM (eDRAM), embedded SRAM (eSRAM), embedded flash memory, or another type of embedded memory.

Storage device 1060 can include drive unit (e.g., hard disk drive (HHD), solid-state drive (SSD), or another mass storage device). Storage device 1060 can include a machine-readable medium 1062 and processing circuitry. Machine-readable medium 1062 can store one or more sets of data structures or instructions 1064 (e.g., software) embodying or used by any one or more of the techniques or functions described herein. Instructions 1064 may also reside, completely or at least partially, within memory device 1020, memory controller 1030, processor 1015, or graphics controller 1040 during execution thereof by system (e.g., machine) 1000.

In an example, one of (or any combination of) processor 1015, memory device 1020, memory controller 1030, graphics controller 1040, and storage device 1060 may constitute machine-readable media. Non-limiting machine-readable medium examples may include solid-state memories and optical and magnetic media. Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

FIG. 10 shows machine-readable medium 1062 as a single medium as an example. However, the term “machine-readable medium” may include a single medium or multiple media (e.g., a centralized or distributed database, and/or associated caches and servers) configured to store instructions 1064. Further, the term “machine-readable medium” may include any medium that is capable of storing, encoding, or carrying instructions for execution by system 1000 and that causes system 1000 to perform any one or more of the techniques of the present disclosure, or that is capable of storing, encoding or carrying data structures used by or associated with such instructions. In some examples, machine-readable media may include non-transitory machine-readable media. In some examples, machine-readable media may include machine-readable media that is not a transitory propagating signal.

Display 1052 can include a liquid crystal display (LCD), a touchscreen (e.g., capacitive or resistive touchscreen), or another type of display. Pointing device 1056 can include a mouse, a stylus, or another type of pointing device. In some structures, system 1000 does not have to include a display. Thus, in such structures, display 1052 can be omitted from system 1000.

Antenna 1058 can include one or more directional or omnidirectional antennas, including, for example, dipole antennas, monopole antennas, patch antennas, loop antennas, microstrip antennas, or other types of antennas suitable for transmission of radio frequency (RF) signals. In some structures, system 1000 does not have to include an antenna. Thus, in such structures, antenna 1058 can be omitted from system 1000.

I/O controller 1050 can include a communication module for wired or wireless communication (e.g., communication through one or more antennas 1058). Such wireless communication may include communication in accordance with WiFi communication technique, Long Term Evolution Advanced (LTE-A) communication technique, or other communication techniques.

I/O controller 1050 can also include a module to allow system 1000 to communicate with other devices or systems in accordance with to one or more of the following standards or specifications (e.g., I/O standards or specifications), including Universal Serial Bus (USB), DisplayPort (DP), High-Definition Multimedia Interface (HDMI), Thunderbolt, Peripheral Component Interconnect Express (PCIe), Ethernet, and other specifications.

Connector 1055 can include terminals (e.g., pins) to allow system 1000 to receive a connection (e.g., an electrical connection) from an external device (or system). This may allow system 1000 to communicate (e.g., exchange information) with such a device (or system) through connector 1055. Connector 1055 and at least a portion of bus 1070 can include conductive lines that conform with at least one of USB, DP, HDMI, Thunderbolt, PCIe, Ethernet, and other specifications.

FIG. 10 shows the components (e.g., devices) of system 1000 arranged separately from each other as an example. For example, each of processor 1015, memory device 1020, memory controller 1030, graphics controller 1040, and I/O controller 1050 can be included in (e.g., formed in or formed on) a separate integrated circuit (IC) chip (e.g., separate semiconductor die or separate IC die). In some structures of system 1000, two or more components (e.g., processor 1015, memory device 1020, graphics controller 1040, and I/O controller 1050) of system 1000 can be included in (e.g., formed in or formed on) the same IC chip (e.g., same semiconductor die), forming a SoC, or alternatively, a SiP.

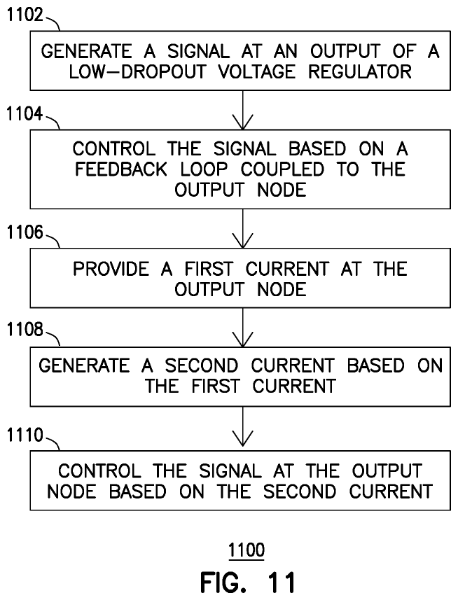

FIG. 11 is a flowchart showing a method 1100 of operating an apparatus that can include a voltage regulator, according to some embodiments described herein. The method 1100 can be performed by any of the apparatuses (e.g., apparatuses 100, 400, and 500 and system 1000) described above with reference to FIG. 1 through FIG. 10. Some of the activities in method 1100 may be performed by hardware, software, firmware, or any combination of hardware, software, and firmware of a device (e.g., processor 1015, memory device 1020, memory controller 1030, graphics controller 1040, or I/O controller 1050 of system 1000) or a system (e.g., system 1000).

As shown in FIG. 11, method 1100 can include activities (e.g., operations) 1102, 1104, 1106, 1108, and 1110. Activity 1102 can include generating a signal at an output node of a LDO voltage regulator. The signal can include voltage (signal) V_{OUT} of voltage regulator 101, 401, or 501, described above. Activity 1104 can include controlling the signal at the output node based on a feedback loop coupled to the output node. The feedback loop can include circuit path 124 described above (e.g., with reference to FIG. 1, FIG. 4, and FIG. 5A). In activity 1104, controlling the signal at the output node can include injecting zero in a control loop of the LDO voltage regulator responsive to the output node having a first capacitance, and cancelling zero in the control loop of the LDO voltage regulator responsive to the output node having a second capacitance. The first capacitance can be greater than the second capacitance. In an example, the first capacitance and the second capacitance can be in a capacitance range of zero to 50 nF. In activity 1104, controlling the signal at the output node can include providing a frequency compensation RC network in the LDO voltage regulator to adjust a location of zero in the in the control loop of the LDO voltage regulator based on the second current.

Activity 1106 of method 1100 can include providing a first current at the output node. The first current can include current I_{LOAD} described above. Activity 1108 can include generating a second current based on the first current. The second current can include current I_{REP} described above. In activity 1108, generating the second current can include mirroring the first current to generate the second current. Activity 1110 can include controlling the signal at the output node based on the second current.

Method 1100 described above can include fewer or more activities relative to activities 1102, 1104, 1106, 1108, and 1110 in FIG. 11. For example, method 1100 can include providing code information to a circuit coupled between the output node and a supply node, and controlling the signal at the output node based on the code information. The code information can include first control information obtained from a first operation performed on the circuit, and second control information obtained from a second operation performed circuit while the first information is provided to gates of transistors of the circuit. Providing code information in method 1100 can include performing a first operation on circuitry different from a LDO voltage regulator to obtain a first portion of the code information and providing the first portion of the code information to input nodes of the circuit, and performing a second operation on the circuit while the first portion of the code information are provided at the input nodes of the circuit to obtain a second portion of the code information, wherein the code information includes a combination of the first portion of the code information and the second portion of the code information.

In another example, method 1100 can include generating a third current based on the first current, and generating digital information based on the third current.

Method 1100 can include additional activities including activities and operations of the apparatuses (e.g., apparatuses 100, 200, and 500 and system 1000) described above with reference to FIG. 1 through FIG. 10. Method 1100 can have improvements and benefits similar to those of apparatus 100, 400, 500, and system 1000.

The illustrations of the apparatuses (e.g., apparatuses 100, 400, and 500 and system 1000) and methods (e.g., method of operating (e.g., apparatuses 100, 400, and 500 system 1000) described above are intended to provide a general understanding of the structure of different embodiments and are not intended to provide a complete description of all the elements and features of an apparatus that might make use of the structures described herein. An apparatus herein refers to, for example, either a device (e.g., voltage regulators 101, 401, or 501) or a system (e.g., system 1000 that can include voltage regulator 101, 401, or 501).

Any of the components described above with reference to FIG. 1 through FIG. 11 can be implemented in a number of ways, including simulation via software. Thus, apparatuses (e.g., voltage regulator 101, 401, or 501, or part of the voltage regulator) may all be characterized as “modules” (or “module”) herein. Such modules may include hardware circuitry, single-and/or multi-processor circuits, memory circuits, software program modules and objects and/or firmware, and combinations thereof, as desired and/or as appropriate for particular implementations of various embodiments. For example, such modules may be included in a system operation simulation package, such as a software electrical signal simulation package, a power usage and ranges simulation package, a capacitance-inductance simulation package, a power/heat dissipation simulation package, a signal transmission-reception simulation package, and/or a combination of software and hardware used to operate or simulate the operation of various potential embodiments.

The apparatuses and methods described above can include or be included in high-speed computers, communication and signal processing circuitry, single-or multi-processor modules, single or multiple embedded processors, multicore processors, message information switches, and application-specific modules including multilayer, multichip modules. Such apparatuses may further be included as subcomponents within a variety of other apparatuses (e.g., electronic systems), such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others.

In the detailed description and the claims, the terms “first,” “second,” and “third,” etc., are used merely as labels, and are not intended to impose numerical requirements on their objects.

In the detailed description and the claims, the term “adjacent” generally refers to a position of a thing being next to (e.g., either immediately next to or close to with one or more things between them) or adjoining another thing (e.g., abutting it or contacting it (e.g., directly coupled to) it).

In the detailed description and the claims, a list of items joined by the term “at least one of” can mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A can include a single element or multiple elements. Item B can include a single element or multiple elements. Item C can include a single element or multiple elements.

In the detailed description and the claims, a list of items joined by the term “one of” can mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A can include a single element or multiple elements. Item B can include a single element or multiple elements. Item C can include a single element or multiple elements.

Described implementations of the subject matter can include one or more features, alone or in combination as illustrated below by way of examples.

Example 1 is an apparatus comprising a LDO voltage node, a driver including an output node coupled to the LDO voltage node to provide a current at the LDO voltage node, a comparator including an input node coupled to the output node of the driver, and an output node coupled to an input node of the driver, a current generator coupled to the driver to generate a second current based on the first current, and a frequency compensation network coupled to the comparator and the current generator.

In Example 2, the subject matter of Example 1 includes subject matter wherein the current generator includes a current mirror circuit, the current mirror circuit includes a first branch to conduct the second current, and a second branch coupled to the first branch, and the frequency compensation network includes a capacitor coupled to the second branch and the output node of the comparator.

In Example 3, the subject matter of Example 2 includes subject matter wherein the driver includes a first transistor including a first terminal coupled to a supply node, a second terminal coupled to the LDO voltage node, and the current generator includes a second transistor including a gate coupled to a gate of the first transistor, and a terminal coupled to the LDO voltage node.

In Example 4, the subject matter of Example 3 includes subject matter wherein the frequency compensation network includes an additional capacitor coupled to the output node of the comparator.

In Example 5, the subject matter of Example 1 includes subject matter wherein the comparator includes a differential amplifier including an input node coupled to the output node of the driver, an output node coupled to the frequency compensation network, a buffer including an input node coupled to the output node of the differential amplifier, and an output node coupled to the input node of the driver.

In Example 6, the subject matter of Example 5 includes subject matter wherein the frequency compensation network includes a capacitor including a first plate coupled to the input node of the driver, a transistor including a first terminal coupled to a second plate of the capacitor, and a second terminal coupled to the input node of the buffer.

In Example 7, the subject matter of Example 1 includes subject matter wherein the apparatus comprises a system on chip (SoC), the SoC including an integrated circuit (IC) die, and wherein the driver, the comparator, the current generator, and the frequency compensation network are included in the IC die.

In Example 8, the subject matter of Example 2 includes subject matter wherein the current generator includes a unity gain buffer coupled to the comparator and the dies frequency compensation network.

In Example 9, the subject matter of Example 3 includes subject matter wherein the second transistor has a size smaller than the first transistor.

In Example 10, the subject matter of Example 3 includes subject matter wherein the second current is less than the first current.

In Example 11, the subject matter of any of Examples 1-10 includes, measurement circuitry to generate coupled to the driver and the LDO voltage node to generate a third current based on the first current, and to generate digital information based on the third current.

In Example 12, the subject matter of Example 11 includes subject matter wherein the third current is less than the first current.

In Example 13, the subject matter of Examples 1-3 includes subject matter wherein the voltage sensor includes a comparator including a first input node coupled to the LDO voltage node, and a second input node coupled to a reference voltage generator.

Example 14 is an apparatus comprising a voltage regulator including a transistor, the transistor including a first terminal coupled to a supply node and a second terminal coupled to an output node of the voltage regulator, measurement circuitry to measure a first current based on a second current between the supply node and the output node, and a voltage sensor including a comparator, the comparator including a first input node coupled to the output node and a second input node coupled to a reference voltage generator.

In Example 15, the subject matter of Example 14 includes subject matter wherein the transistor is a first transistor, and wherein the voltage regulator includes a second transistor, the second transistor including a gate coupled to a gate of the first transistor, and a terminal coupled to the output node of the voltage regulator, and the measurement circuitry includes a third transistor, the third transistor including a gate coupled to a gate of the first transistor, and a terminal coupled to the output node of the voltage regulator.

In Example 16, the subject matter of Example 14 includes subject matter wherein the transistor is a first transistor, and wherein the voltage regulator includes a second transistor, the second transistor including a gate coupled to a gate of the first transistor, and a terminal coupled to the supply node, and the measurement circuitry includes a third transistor, the third transistor including a gate coupled to a gate of the first transistor, and a terminal coupled to the supply node.

In Example 17, the subject matter of any of Examples 14-16 includes subject matter wherein the voltage regulator includes a current mirror circuit coupled to the transistor.

In Example 18, the subject matter of any of Examples 14-17 includes subject matter wherein the voltage regulator includes a capacitor coupled to the current mirror circuit.

In Example 19, the subject matter of any of Examples 14-18 includes subject matter wherein the voltage regulator includes a differential amplifier including an input node coupled to the output node of the voltage regulator, and a buffer including an input node coupled to an output node of the differential amplifier, and an output node coupled to a gate of the transistor.

In Example 20, the subject matter of any of Examples 14-19 includes subject matter wherein the voltage sensor includes a counter coupled to an output node of the comparator.

In Example 21, the subject matter of any of Examples 14-20 includes subject matter wherein the voltage regulator includes circuit paths coupled in parallel between an additional supply node and the output node of the voltage regulator.

In Example 22, the subject matter of any of Examples 14-21 includes subject matter wherein the measurement circuitry includes a circuit to provide digital information based on measurement of the first current.

In Example 23, the subject matter of any of Examples 14-22 includes subject matter wherein the apparatus comprises a system in a package (SiP), the SiP including an integrated circuit (IC) die, and wherein the voltage regulator, the measurement circuitry, and the voltage sensor are included in the IC die.

In Example 24, the subject matter of Example 22 includes subject matter wherein the second transistor has a smaller size than the first transistor.

In Example 25, the subject matter of Example 23 includes subject matter wherein the third transistor has a smaller size than the first transistor.

In Example 26, the subject matter of Example 22 includes subject matter wherein the first transistor, the second transistor, and the third transistor have a same transistor type.

In Example 27, the subject matter of Example 22 includes subject matter wherein the first transistor, the second transistor, and the third transistor include n-type transistors.

In Example 28, the subject matter of Example 23 includes subject matter wherein the second transistor has a smaller size than the first transistor.

In Example 29, the subject matter of Example 28 includes subject matter wherein the third transistor has a smaller size than the first transistor.

In Example 30, the subject matter of Example 22 includes subject matter wherein the first transistor, the second transistor, and the third transistor have a same transistor type.

In Example 31, the subject matter of Example 22 includes subject matter wherein the first transistor, the second transistor, and the third transistor include p-type transistors.

In Example 32, the subject matter of Example 21 includes subject matter wherein the transistor is a first transistor, and wherein the voltage regulator includes a second transistor to conduct a first current based on a current through the first transistor, and the measurement circuitry includes a third transistor to conduct second current based on the current through the first transistor.

In Example 33, the subject matter of Example 19 includes subject matter wherein the voltage regulator includes an additional capacitor coupled to the current mirror circuit.

In Example 34, the subject matter of Example 22 includes subject matter wherein the circuit paths include transistors coupled to the additional supply node, and the voltage sensor is to generate part of code information to control the transistors.

In Example 35, the subject matter of any of Examples 23-35 includes, calibration circuitry coupled to the counter to generate offset information, wherein the offset information is included in the code information.

In Example 36, the subject matter of Example 35 includes subject matter wherein the offset information is based on differences in a voltage at the output node and voltages of a range of reference voltages.

In Example 37, the subject matter of Example 15 includes subject matter wherein each of the circuit paths include transistors coupled between the additional supply node supply node and the output node of the voltage regulator.

In Example 38, the subject matter of Example 37 includes subject matter wherein the transistors have different transistor types.

In Example 39, the subject matter of Example 38 includes subject matter wherein the multiple transistors have p-type and n-type transistors.

In Example 40, the subject matter of Example 15 includes subject matter wherein the transistor is a first transistor, and the voltage regulator includes a second transistor, the second transistor including a gate coupled to a gate of the first transistor, and a terminal coupled to the output node of the voltage regulator.

In Example 41, the subject matter of Example 40 includes subject matter wherein the terminal of the second transistor includes a source of the second transistor.

In Example 42, the subject matter of Example 15 includes subject matter wherein the transistor is a first transistor, and the voltage regulator includes a second transistor, the second transistor including a gate coupled to a gate of the first transistor, and a terminal coupled to the supply node.

In Example 43, the subject matter of Example 42 includes subject matter wherein the terminal of the second transistor includes a source of the second transistor.

In Example 44, the subject matter of Example 15 includes subject matter wherein the transistor is a first transistor, and the measurement circuitry includes a second transistor, the second transistor including a gate coupled to a gate of the first transistor, and a terminal coupled to the output of the voltage regulator.

In Example 45, the subject matter of Example 44 includes subject matter wherein the terminal of the second transistor includes a source of the second transistor.

In Example 46, the subject matter of Example 15 includes subject matter wherein the transistor is a first transistor, and the measurement circuitry includes a second transistor, the second transistor including a gate coupled to a gate of the first transistor, and a terminal coupled to the supply node.

In Example 47, the subject matter of Example 46 includes subject matter wherein the terminal of the second transistor includes a source of the second transistor.

In Example 48, the subject matter of Example 15 includes subject matter wherein the measurement circuitry includes a multiplexer, and a transistor including a gate coupled to a gate of the transistor of the voltage regulator terminal, and a terminal coupled to an input node of the multiplexer.

In Example 49, the subject matter of Example 48 includes subject matter wherein the measurement circuitry includes an additional multiplexer, and the terminal of the transistor of the measurement circuitry is coupled to an input node of the additional multiplexer.

In Example 50, the subject matter of any of Examples 48-49 includes subject matter wherein the measurement circuitry includes a double cascode circuit coupled to an output node of the first multiplexer and an output node of the second multiplexer.

In Example 51, the subject matter of Example 50, the measurement circuitry includes a first integrator coupled to the double-cascode circuit, and second integrator coupled to the double-cascode circuit.

In Example 52, the subject matter of Example 51 includes subject matter wherein the measurement circuitry includes a first chopper circuit coupled to the first integrator, and a second chopper circuit coupled to the second integrator.

In Example 53, the subject matter of Example 52 includes subject matter wherein the measurement circuitry includes a first comparator coupled to the first chopper circuit, and a second comparator coupled to the second chopper circuit.

In Example 54, the subject matter of Example 53 includes subject matter wherein the measurement circuitry includes a latch coupled to the first comparator and the second comparator.

In Example 55, the subject matter of Example 52 includes subject matter wherein the measurement circuitry includes a circuit coupled to the latch to provide digital information based on measurement of the first current.

Example 56 is a method comprising generating a signal at an output node of a LDO voltage generator, controlling the signal at the output node based on a feedback loop coupled to the output node, providing a first current at the output node, generating a second current based on the first current, and controlling the signal at the output node based on the second current.

In Example 57, the subject matter of Example 56 includes, providing code information to a circuit coupled between the output node and a supply node, and controlling the signal at the output node based on the code information.

In Example 58, the subject matter of any of Examples 56-57 includes, generating a third current based on the first current, and generating digital information based on the third current.

In Example 59, the subject matter of any of Examples 56-58 includes subject matter wherein controlling the signal at the output node based on the second current includes injecting zero in a control loop of the LDO voltage regulator responsive to the output node having a first capacitance, and cancelling zero in the control loop of the LDO voltage regulator responsive to the output node having a second capacitance.

In Example 60, the subject matter of Example 59 includes subject matter wherein the first capacitance is greater than the second capacitance.

In Example 61, the subject matter of Example 59 includes subject matter wherein the first capacitance and the second capacitance are in a capacitance range of zero to 50 nanofarads (nF).

In Example 62, the subject matter of any of Examples 56-61 includes subject matter wherein controlling the signal at the output node based on the second current includes providing a capacitance-resistance (RC) network in the LDO voltage regulator to adjust a location of zero in the in the control loop of the LDO voltage regulator based on the second current.

In Example 63, the subject matter of any of Examples 56-62 includes subject matter wherein generating the second current includes mirroring the first current to generate the second current.

In Example 64, the subject matter of any of Examples 58-63 includes subject matter wherein generating the third current includes mirroring the first current to generate the third current.

In Example 65, the subject matter of any of Examples 57-64 includes subject matter wherein the code information includes first control information obtained from a first operation performed on the circuit, and second control information obtained from performing a second operation on the circuit while the first information is provided to gates of transistors of the circuit.

In Example 66, the subject matter of any of Examples 57-65 includes subject matter wherein providing code information includes performing a first operation on circuitry different from LDO voltage regulator to obtain a first portion of the code information, providing the first portion of the code information to input nodes of the circuit, and performing a second operation on the circuit while the first portion of the code information are provided at the input nodes of the circuit to obtain a second portion of the code information, wherein the code information includes a combination of the first portion of the code information and the second portion of the code information.

In Example 67, the subject matter of any of Examples 57-66 includes subject matter wherein the circuitry includes an additional circuit having a structure based on a structure of the circuit.

In Example 68, the subject matter of any of Examples 65-67 includes subject matter wherein performing a second operation includes comparing a voltage at the output node of the LDO voltage generator with different referent voltages to provide result information, wherein the second portion of the code information is based on the result information.

Example 69 is an apparatus comprising means to implement any of Examples 1-68.

Example 70 is a system to implement any of Examples 1-68.

Example 71 is a method to implement any of Examples 1-68.

The subject matter of Examples 1-71 may be combined in any combination.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a low-dropout (LDO) voltage node;
a driver including an output node coupled to the LDO voltage node to provide a current at the LDO voltage node;
a comparator including an input node coupled to the output node of the driver, and an output node coupled to an input node of the driver;
a current generator coupled to the driver to generate a second current based on the first current; and
a frequency compensation network coupled to the comparator and the current generator.

2. The apparatus of claim 1, wherein the current generator includes a current mirror circuit, the current mirror circuit includes a first branch to conduct the second current, and a second branch coupled to the first branch; and
the frequency compensation network includes a capacitor coupled to the second branch and the output node of the comparator.

3. The apparatus of claim 2, wherein:
the driver includes a first transistor including a first terminal coupled to a supply node, a second terminal coupled to the LDO voltage node; and
the current generator includes a second transistor including a gate coupled to a gate of the first transistor, and a terminal coupled to the LDO voltage node.

4. The apparatus of claim 3, wherein the frequency compensation network includes an additional capacitor coupled to the output node of the comparator.

5. The apparatus of claim 1, wherein the comparator includes:
a differential amplifier including an input node coupled to the output node of the driver, and an output node coupled to the frequency compensation network; and
a buffer including an input node coupled to the output node of the differential amplifier, and an output node coupled to the input node of the driver.

6. The apparatus of claim 5, wherein the frequency compensation network includes:
a capacitor including a first plate coupled to the input node of the driver; and
a transistor including a first terminal coupled to a second plate of the capacitor, and a second terminal coupled to the input node of the buffer.

7. The apparatus of claim 1, wherein the apparatus comprises a system on chip (SoC), the SoC including an integrated circuit (IC) die, and wherein the driver, the comparator, the current generator, and the frequency compensation network are included in the IC die.

8. An apparatus comprising:
a voltage regulator including a transistor, the transistor including a first terminal coupled to a supply node and a second terminal coupled to an output node of the voltage regulator;
measurement circuitry to measure a first current based on a second current between the supply node and the output node; and
a voltage sensor including a comparator, the comparator including a first input node coupled to the output node and a second input node coupled to a reference voltage generator.

9. The apparatus of claim 8, wherein the transistor is a first transistor, and wherein:
the voltage regulator includes a second transistor, the second transistor including a gate coupled to a gate of the first transistor, and a terminal coupled to the output node of the voltage regulator; and
the measurement circuitry includes a third transistor, the third transistor including a gate coupled to a gate of the first transistor, and a terminal coupled to the output node of the voltage regulator.

10. The apparatus of claim 8, wherein the transistor is a first transistor, and wherein:
the voltage regulator includes a second transistor, the second transistor including a gate coupled to a gate of the first transistor, and a terminal coupled to the supply node;
the measurement circuitry includes a third transistor; and
the third transistor including a gate coupled to a gate of the first transistor, and a terminal coupled to the supply node.

11. The apparatus of claim 8, wherein the voltage regulator includes a current mirror circuit coupled to the transistor.

12. The apparatus of claim 11, wherein the voltage regulator includes a capacitor coupled to the current mirror circuit.

13. The apparatus of claim 8, wherein the voltage regulator includes:
a differential amplifier including an input node coupled to the output node of the voltage regulator; and
a buffer including an input node coupled to an output node of the differential amplifier, and an output node coupled to a gate of the transistor.

14. The apparatus of claim 8, wherein the voltage sensor includes a counter coupled to an output node of the comparator.

15. The apparatus of claim 8, wherein the voltage regulator includes circuit paths coupled in parallel between an additional supply node and the output node of the voltage regulator.

16. The apparatus of claim 8, wherein the measurement circuitry includes a circuit to provide digital information based on measurement of the first current.

17. The apparatus of claim 8, wherein the apparatus comprises a system in a package (SiP), the SiP including an integrated circuit (IC) die, and wherein the driver is included in the IC die.

18. A method comprising:
generating a signal at an output node of a low-dropout (LDO) voltage regulator;
controlling the signal at the output node based on a feedback loop coupled to the output node;
providing a first current at the output node;
generating a second current based on the first current; and
controlling the signal at the output node based on the second current.

19. The method of claim 18, further comprising:
providing code information to a circuit coupled between the output node and a supply node; and
controlling the signal at the output node based on the code information.

20. The method of claim 18, further comprising:
generating a third current based on the first current; and
generating digital information based on the third current.
